(19) United States
(12) Patent Application Publication
(10) Pub. No.: US 2025/0264590 A1
(43) Pub. Date: Aug. 21, 2025

(54) VEHICLE

(71) Applicant: HONDA MOTOR CO., LTD., Tokyo (JP)

(72) Inventors: Takahiro Kuroki, Wako-shi (JP); Hideyuki Akaba, Wako-shi (JP); Tomoya Amari, Wako-shi (JP); Kazuhiro Tada, Wako-shi (JP)

(73) Assignee: HONDA MOTOR CO., LTD., Tokyo (JP)

(21) Appl. No.: 19/042,299

(22) Filed: Jan. 31, 2025

(30) Foreign Application Priority Data
Feb. 20, 2024 (JP) 2024-023905

(51) Int. Cl. G01S 7/497; G01S 7/481; G01S 17/87; G01S 17/931

(52) U.S. Cl. CPC G01S 7/4972; G01S 7/4811; G01S 17/87; G01S 17/931

(57) ABSTRACT

A vehicle comprising: a rotary reference LiDAR; a plurality of fixed LiDARs; and a processing unit configured to execute aiming processing of the plurality of fixed LiDARs using the reference LiDAR. For example, the reference LiDAR has a view angle range of 360 degrees in a yaw direction; each of the plurality of fixed LiDARs has a predetermined view angle range in the yaw direction; and the view angle range of the reference LiDAR and the view angle range of each fixed LiDAR at least partially overlap.

### CROSS-REFERENCE TO RELATED APPLICATION(S)

This application claims priority to and the benefit of Japanese Patent Application No. 2024-023905 filed on Feb. 20, 2024, the entire disclosure of which is incorporated herein by reference.

### BACKGROUND OF THE INVENTION

### Field of the Invention

The present invention relates to a vehicle.

### Description of the Related Art

Aiming (optical axis adjustment) processing of an object detection device such as a radar or a light detection and ranging (LiDAR) mounted on a vehicle is known. Japanese Patent Laid-Open No. 2002-131434 discloses that an aiming jig is installed at a predetermined distance forward of a vehicle on a longitudinal axis of the vehicle, and a reference reflector of the aiming jig is detected to perform aiming in the vertical direction.

However, the technique described in Japanese Patent Laid-Open No. 2002-131434 requires a large-scale aiming jig, and thus has a problem that it is difficult to efficiently perform aiming of a plurality of sensors installed in a vehicle.

### SUMMARY OF THE INVENTION

The present invention has been made in view of the above problem, and provides a technique for achieving efficient aiming.

According to one aspect of the present invention, there is provided a vehicle comprising: a rotary reference LiDAR; a plurality of fixed LiDARs; and a processing unit configured to execute aiming processing of the plurality of fixed LiDARs using the reference LiDAR.

### BRIEF DESCRIPTION OF THE DRAWINGS

FIG. 1 is a diagram illustrating an example of an external configuration of a vehicle according to an embodiment;

FIG. 2 is a diagram illustrating a configuration example of the vehicle according to the embodiment;

FIG. 3 is an explanatory diagram of aiming processing according to the embodiment;

FIG. 4 is a diagram illustrating a relationship between detection ranges of a reference LiDAR and a fixed LiDAR when a stand is lifted according to the embodiment;

FIG. 5 is a diagram illustrating a relationship between detection ranges of the reference LiDAR and the fixed LiDAR when the stand is lowered according to the embodiment;

FIG. 6 is a partially enlarged view of a vehicle according to an embodiment;

FIG. 7 is a diagram illustrating an exemplary structure for mounting a reference LiDAR to a stand according to the embodiment;

FIG. 8 is a diagram illustrating an exemplary structure for mounting the reference LiDAR to the stand according to the embodiment;

FIG. 9 is a perspective view of an internal structure of a vehicle according to an embodiment;

FIG. 10 is a front view of the internal structure of the vehicle according to the embodiment;

FIG. 11 is a top view of the internal structure of the vehicle according to the embodiment;

FIG. 12 is an explanatory diagram of an example of vehicle superimposition according to an embodiment (before superimposition); and

FIG. 13 is an explanatory diagram of an example of vehicle superimposition according to the embodiment (after superimposition).

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

The vertical direction, the horizontal direction, and the front-and-rear direction in the drawings indicate directions defined with respect to the vehicle.

### First Embodiment

### <Configuration>

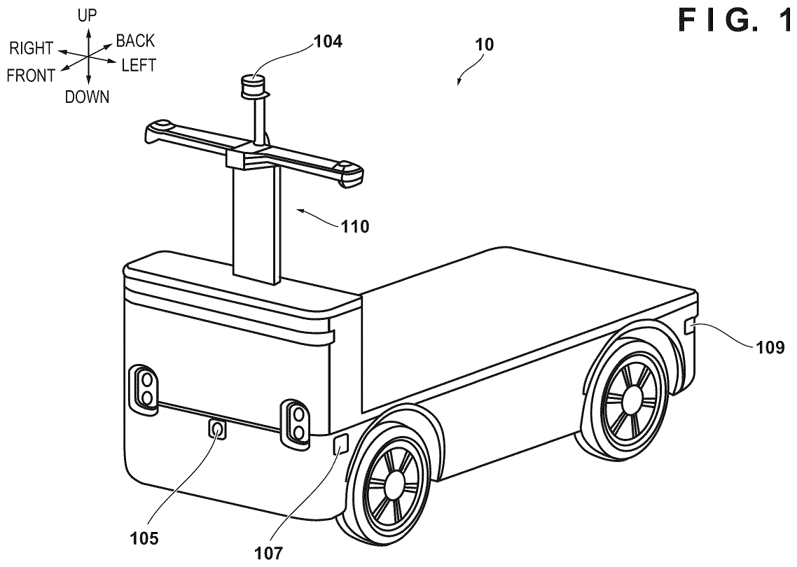

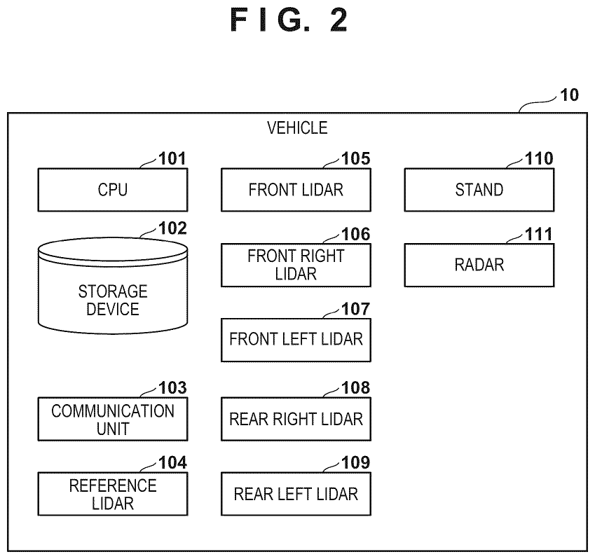

FIG. 1 is a diagram illustrating an example of an external configuration of a vehicle according to an embodiment. FIG. 2 is a diagram illustrating a configuration example of the vehicle according to the embodiment. A vehicle 10 is, for example, an automatic guided vehicle, and is an autonomous work vehicle capable of conveying a mounted object such as a cargo.

The vehicle 10 includes a CPU 101, a storage device 102, and a communication unit 103. A control operation of the vehicle 10 is achieved by the CPU 101 reading and executing a computer program stored in the storage device 102. The CPU 101 may be one or more CPUs. The storage device 102 is one or more memories that store several types of information. For example, information that has been received from another device, a computer program to be read and executed by the CPU 101, and the like are stored. The communication unit 103 has a function of communicating with another device in a wired or wireless manner through a network.

In addition, the vehicle 10 includes a reference LiDAR 104, a front LiDAR 105, a front right LiDAR 106, a front left LiDAR 107, a rear right LiDAR 108, a rear left LiDAR 109, a stand 110, and a radar 111. By arranging the fixed LiDAR at the four corners and the front portion in a lower part of the vehicle, it is possible to obtain a required visual field necessary for automated driving. Note that in the present embodiment, an example will be described in which a total of five fixed LiDARs of the front LiDAR 105 to the rear left LiDAR 109 are provided as a plurality of fixed LiDARs (LiDARs fixedly installed in vehicle), but the number of fixed LiDARs is not limited to five, and may be a larger number or a smaller number.

The reference LiDAR 104 is, for example, a rotary light detection and ranging (LiDAR) detachable from the vehicle 10. The reference LiDAR 104 is a LiDAR for detecting a target around the vehicle 10, and can rotate. This makes it possible to have a view angle range of 360 degrees in the yaw direction.

The front LiDAR 105 is a fixed LiDAR that detects the front direction of the vehicle 10, and is arranged in a front portion of the vehicle 10. The front right LiDAR 106 is a fixed LiDAR that detects the front right direction of the vehicle 10, and is arranged in a front right portion of the vehicle 10. The front left LiDAR 107 is a fixed LiDAR that detects the front left direction of the vehicle 10, and is arranged in a front left portion of the vehicle 10. The rear right LiDAR 108 is a fixed LiDAR that detects the rear right direction of the vehicle 10, and is arranged in a rear right portion of the vehicle 10. The rear left LiDAR 109 is a fixed LiDAR that detects the rear left direction of the vehicle 10, and is arranged in a rear left portion of the vehicle 10. Each fixed LiDAR has a predetermined view angle range in the yaw direction.

The stand 110 is a global navigation satellite system (GNSS) stand provided in a front portion of vehicle 10. A GNSS sensor is installed in the GNSS stand, and it is possible to receive GNSS data and grasp position information of the vehicle 10 by using the sensor. In addition, the reference LiDAR 104 can be detachably installed in the stand 110. The stand 110 according to the present embodiment has a T-shape, but is not limited to this shape. The radar 111 is, for example, a millimeter wave radar, detects a target around the vehicle 10 using radio waves, and detects (measures) a distance to the target and a direction (orientation) of the target with respect to the vehicle 10.

### <Aiming Processing>

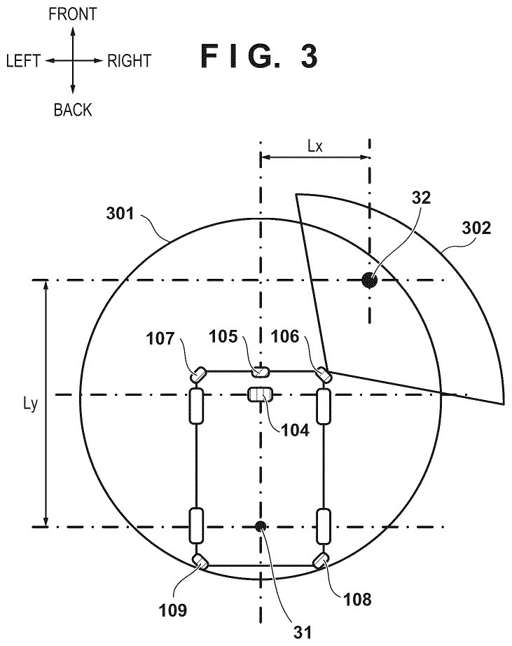

FIG. 3 is an explanatory diagram of aiming processing according to the embodiment. Aiming processing is calibration processing for ensuring correct operation of an electronic control device. In the present embodiment, aiming processing of the fixed LiDAR is performed using the reference LiDAR 104.

In FIG. 3, a control origin 31 is, for example, an axle center point of a rear tire. A target 32 is an object arranged in an arbitrary position around the vehicle 10 for aiming. A view angle range 301 is a view angle range of the reference LiDAR 104 and indicates an angle range of 360 degrees. A view angle range 302 is a view angle range of the front right LiDAR 106. The view angle range 301 of the reference LiDAR 104 and the view angle range 302 of the front right LiDAR 106 overlap.

Note that although the view angle ranges of the front LiDAR 105, the front left LiDAR 107, the rear right LiDAR 108, and the rear left LiDAR 109 are omitted, the view angle range 301 of the reference LiDAR 104 and the view angle range of each fixed LiDAR overlap.

First, the reference LiDAR 104 detects the target 32 and acquires information of coordinates (Lx, Ly) of the target 32 with respect to the control origin 31. It is assumed that the reference LiDAR 104 is calibrated (subjected to aiming processing) in advance with respect to the vehicle 10. Specifically, the reference LiDAR 104 is calibrated (subjected to aiming processing) in advance by performing the aiming processing on one target accurately arranged with respect to the vehicle 10 within the view angle range of the reference LiDAR 104 in advance.

Since the target 32 present within the view angle range 301 of the reference LiDAR 104 calibrated in advance with respect to the vehicle 10 is known to have a relationship with the vehicle 10, if the target 32 is included within the view angle range 302 of the front right LiDAR 106, the relationship with the vehicle 10 can be given to the front right LiDAR 106. That is, the front right LiDAR 106 can acquire the relationship with (=can be aimed) the vehicle 10 via the reference LiDAR 104.

Similarly, for each of the fixed LiDARs other than the front right LiDAR 106, another target is arranged in a position where the view angle ranges of each fixed LiDAR and the reference LiDAR 104 overlap, and similar operation is performed, whereby the aiming processing can be performed.

As described above, the rotary reference LiDAR serving as the master is aimed with respect to the vehicle 10 in advance with high accuracy, and each fixed LiDAR serving as the slave performs its own correction on the basis of a value calculated by the reference LiDAR, whereby aiming of the fixed LiDAR can be easily performed.

### <Stand Lifting and Lowering Operation and Change in Visual Field Overlapping Range>

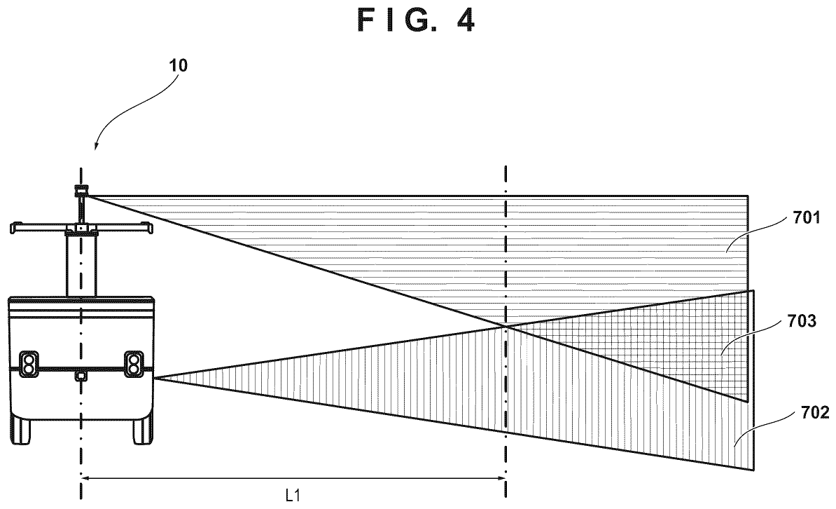

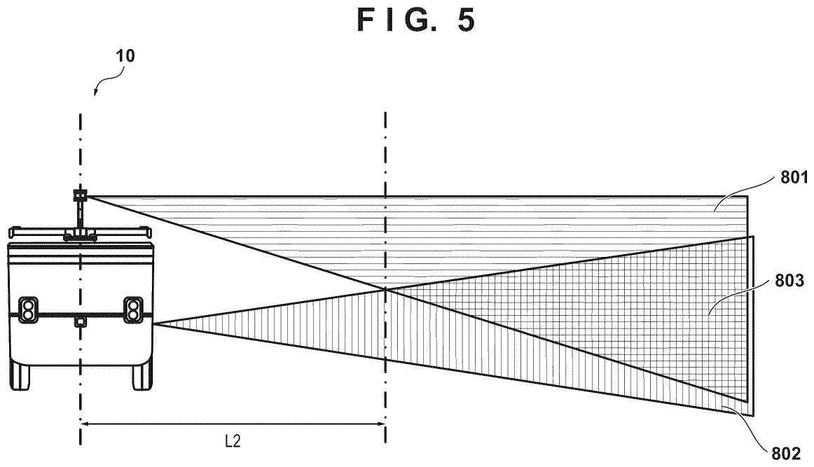

The stand 110 according to the present embodiment may be configured to be movable up and down with respect to the vehicle front structure. Here, FIG. 4 is a diagram illustrating a relationship between detection ranges of the reference LiDAR and a fixed LiDAR when the stand is lifted according to the embodiment. FIG. 5 is a diagram illustrating a relationship between detection ranges of the reference LiDAR and a fixed LiDAR when the stand is lowered according to the embodiment.

As illustrated in FIG. 4, in a state where the stand 110 is lifted with respect to the vehicle front structure (when lifted), the distance from the center of the vehicle 10 to an overlapping position where the visual field range 701 in the vertical direction of the reference LiDAR 104 and the visual field range 702 in the vertical direction of the fixed LiDAR start overlapping is L1. An overlapping range in the vertical direction is indicated by 703. On the other hand, as illustrated in FIG. 5, in a state where the stand 110 is lowered with respect to the vehicle front structure (when lowered), the distance from the center of the vehicle 10 to the overlapping position where the visual field range 801 in the vertical direction of the reference LiDAR 104 and the visual field range 802 in the vertical direction of the fixed LiDAR start overlapping is L2. An overlapping range in the vertical direction is indicated by 803.

As is clear from FIGS. 4 and 5, L2<L1. That is, by lowering the reference LiDAR 104, the target can be arranged at a position closer to the vehicle 10, and the aiming processing can be performed in a narrow space. Therefore, the peripheral space can be efficiently utilized.

In this manner, execution of the processing is facilitated by executing the aiming processing of the plurality of fixed LiDARs in a state where the reference LiDAR 104 is lowered.

As described above, according to the present embodiment, as long as the target is arranged within the view angle range of the reference LiDAR and the fixed LiDAR, the aiming processing of the fixed LiDAR can be executed without requiring accuracy of the position of the target with respect to the vehicle. In addition, by using the rotary reference LiDAR, it is possible to execute the aiming processing of the plurality of fixed LiDARs in a short time since data is acquired by rotating the reference LiDAR once in a state where the targets are arranged for the fixed LiDARs.

As described above, use of the rotary reference LiDAR facilitates aiming of the fixed LiDAR not only at the time of shipment from the factory but also at the time of maintenance at the work site of the vehicle.

### Second Embodiment

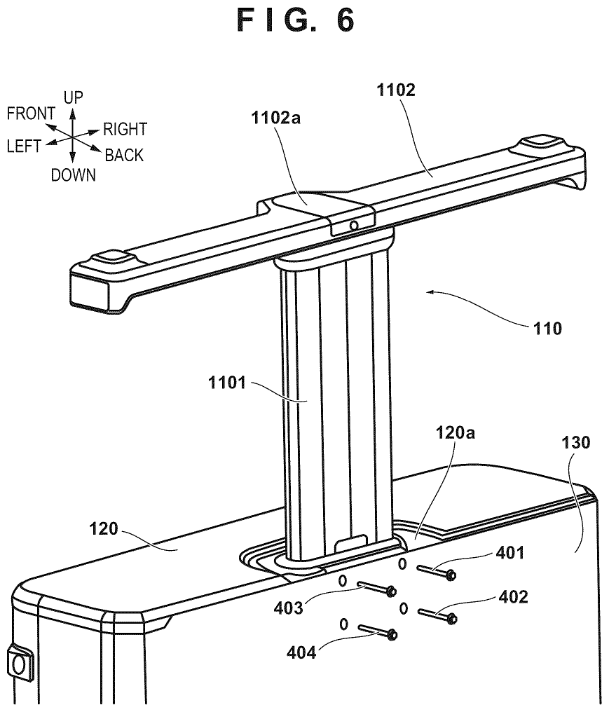

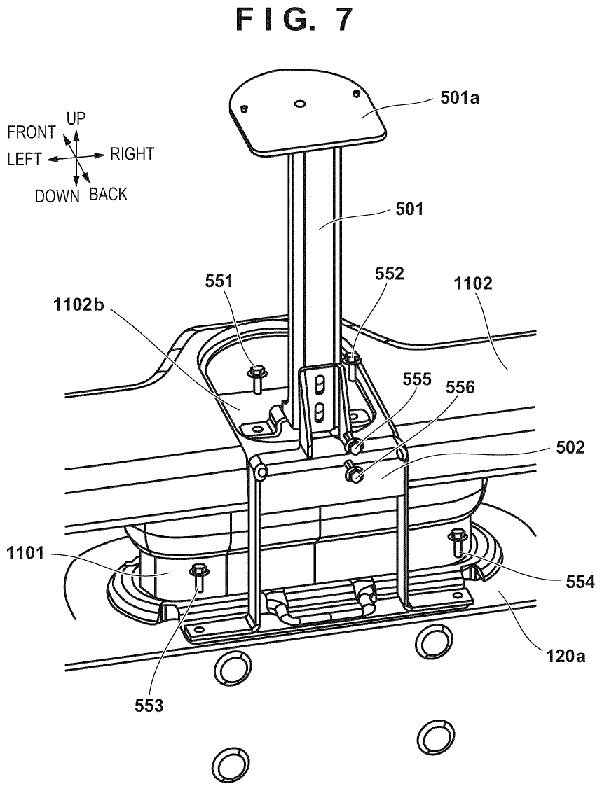

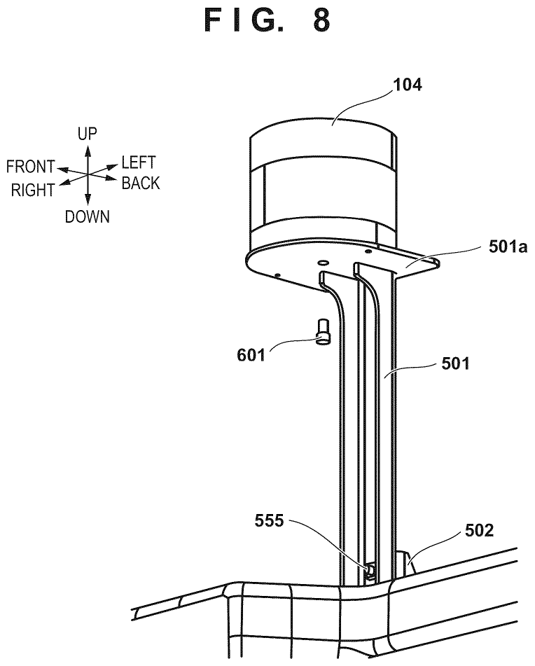

Next, an example of a mounting structure for mounting a reference LiDAR 104 to a stand 110 will be described with reference to FIGS. 6 to 8. FIG. 6 is a partially enlarged view of a vehicle according to an embodiment. FIG. 7 is a diagram illustrating an exemplary structure for mounting the reference LiDAR to the stand according to the embodiment. FIG. 8 is a diagram illustrating an exemplary structure for mounting the reference LiDAR to the stand according to the embodiment.

In FIG. 6, the stand 110 is a T-shaped stand including a vertical member 1101 extending in the vertical direction and a horizontal member 1102 extending in the horizontal direction in an upper portion of the vertical member 1101. The horizontal member 1102 includes a removable lid 1102a. The stand 110 is fixed to the vehicle front structure with a plurality of screws 401 to 404 via a back surface 130 of the vehicle front structure in a state of being lifted in the vertical direction from an upper surface 120 of the vehicle front structure. By removing the plurality of screws 401 to 404, the vertical member 1101 of the stand 110 can be lowered as illustrated in FIG. 7. The state of FIG. 7 illustrates the lowest state, and the vertical member 1101 is not fixed to the vehicle front structure in this state. Therefore, the stand 110 can be lifted by gripping and lifting the stand 110 upward.

As illustrated in FIG. 7, with the lid 1102a removed, a fixing member 501 for mounting the reference LiDAR 104 is mounted to a placement surface 1102b via a plurality of screws 551 and 552. The fixing member 501 includes a placement plate 501a for placing the reference LiDAR 104 thereon.

Then, a bracket 502 is mounted to a surface 120a of the upper surface 120 of the vehicle front structure via a plurality of screws 553 and 554, and is mounted to the fixing member 501 via a plurality of screws 555 and 556. By mounting the bracket 502, the fixing member 501 can be more stably fixed to the stand 110. As illustrated in FIG. 8, the reference LiDAR 104 can be placed on the placement plate 501a of the fixing member 501 and attached via a screw 601.

As described above, according to the present embodiment, the reference LiDAR can be easily detached from the vehicle, and the reference LiDAR can be accurately mounted to the vehicle.

### Third Embodiment

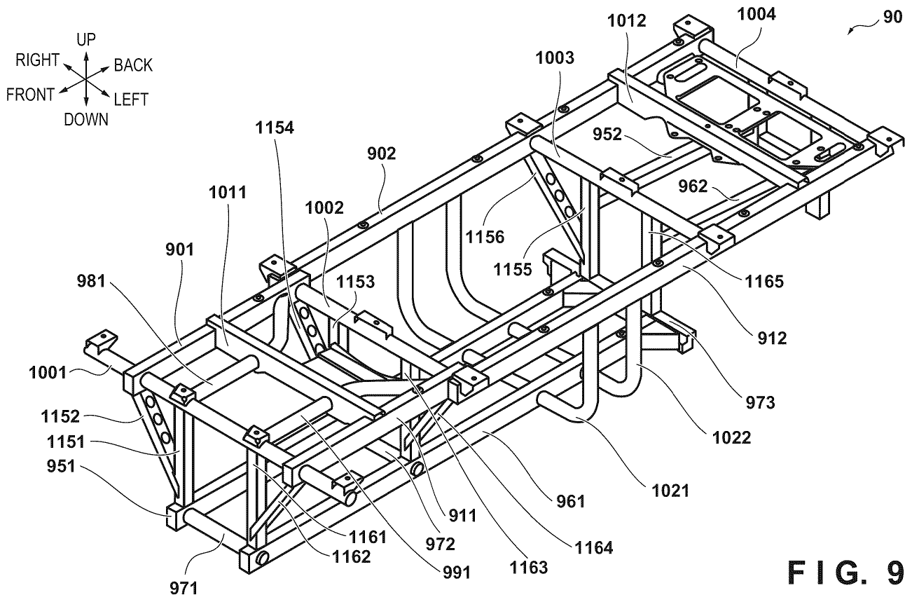

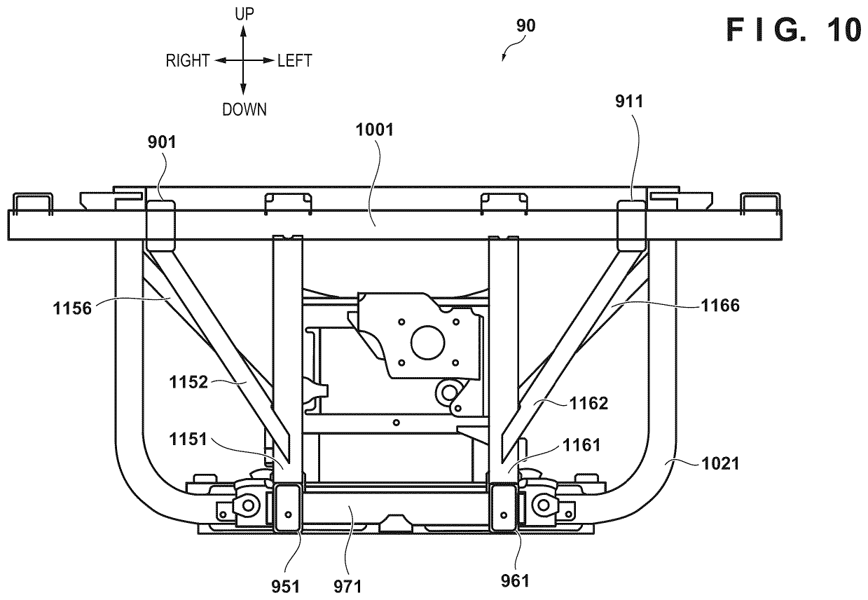

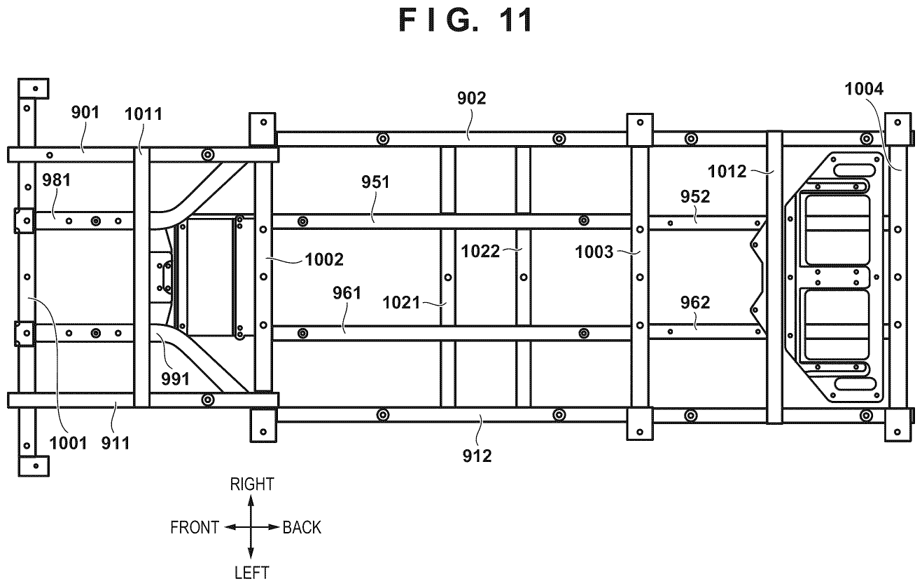

Next, an example of an internal structure of a vehicle according to an embodiment will be described with reference to FIGS. 9 to 11. FIG. 9 is a perspective view of the internal structure of the vehicle according to the embodiment. FIG. 10 is a front view of the internal structure of the vehicle according to the embodiment. FIG. 11 is a top view of the internal structure of the vehicle according to the embodiment. An internal structure 90 is a structure inside the vehicle that extends from a lower portion of the vehicle front structure of the vehicle 10 to a vehicle rear structure corresponding to a cargo bed portion extending from the lower portion toward the vehicle rear.

Reference numerals 901 and 911 denote a pair of upper frame members extending in the longitudinal direction of the vehicle in the vehicle front structure. The upper frame member 901 and the upper frame member 911 are arranged in parallel. Reference numerals 902 and 912 denote a pair of upper frame members extending in the longitudinal direction of the vehicle in the vehicle rear structure. An upper frame member 902 and an upper frame member 912 are arranged in parallel.

Reference numerals 1001 and 1002 denote cylindrical members that connect the upper frame member 901 and the upper frame member 911 and extend in the horizontal direction of the vehicle. The cylindrical member 1001 and the cylindrical member 1002 are arranged in parallel. In the present embodiment, the cylindrical members 1001 and 1002 perpendicularly cross the upper frame members 901 and 911. The cylindrical member 1002 is also connected to the upper frame member 902 and the upper frame member 912.

Reference numerals 1003 and 1004 denote cylindrical members that connect the upper frame member 902 and the upper frame member 912 and extend in the horizontal direction of the vehicle. The cylindrical member 1003 and the cylindrical member 1004 are arranged in parallel. In the present embodiment, the cylindrical members 1003 and 1004 perpendicularly cross the upper frame members 902 and 912. Reference numerals 1011 and 1012 denote reinforcing members extending in the horizontal direction of the vehicle.

Reference numerals 981 and 991 denote cylindrical members partially extending in the longitudinal direction of the vehicle and partially extending in a direction diagonally crossing the longitudinal direction of the vehicle. One end of the cylindrical member 981 is connected to the cylindrical member 1001 and extends through the reinforcing member 1011, and the other end is connected to the upper frame member 901. One end of the cylindrical member 991 is connected to the cylindrical member 1001 and extends through the reinforcing member 1011, and the other end is connected to the upper frame member 911.

Reference numerals 951 and 961 denote a pair of lower frame members extending in the longitudinal direction of the vehicle. The lower frame members 951 and 961 are parallel to the upper frame members 901, 902, 911, and 912. Reference numerals 971 and 972 denote cylindrical members that connect the lower frame member 951 and the lower frame member 961 and extend in the horizontal direction of the vehicle. Reference numerals 1021 and 1022 denote cylindrical members that connect the upper frame member 902, the lower frame member 951, the lower frame member 961, and the upper frame member 912. The cylindrical member 1021 and the cylindrical member 1022 are partially bent and have an L shape. Reference numeral 973 denotes a reinforcing member extending in the horizontal direction of the vehicle and connected to the lower frame member 951 and the lower frame member 961.

Reference numerals 1151 and 1161 denote a pair of vertical frame members extending in the vertical direction of the vehicle. The vertical frame member 1151 and the vertical frame member 1161 are parallel to each other. The vertical frame member 1151 connects the cylindrical member 1001 and the lower frame member 951. The vertical frame member 1161 connects the cylindrical member 1001 and the lower frame member 961.

Reference numerals 1153 and 1163 denote a pair of vertical frame members extending in the vertical direction of the vehicle. The vertical frame member 1153 and the vertical frame member 1163 are parallel to each other. The vertical frame member 1153 connects the cylindrical member 1002 and the lower frame member 951. The vertical frame member 1163 connects the cylindrical member 1002 and the lower frame member 961.

Reference numerals 1155 and 1165 denote a pair of vertical frame members extending in the vertical direction of the vehicle. The vertical frame member 1155 and the vertical frame member 1165 are parallel to each other. The vertical frame member 1155 connects the cylindrical member 1003 and the reinforcing member 973. The vertical frame member 1165 connects the cylindrical member 1003 and the reinforcing member 973.

Reference numerals 952 and 962 denote a pair of middle frame members extending in the longitudinal direction of the vehicle. The middle frame members 952 and 962 are positioned between the upper frame member and the lower frame member in the vertical direction of the vehicle. One end of the middle frame member 952 is connected to the vertical frame member 1155. One end of the middle frame member 962 is connected to the vertical frame member 1165.

Reference numeral 1152 denotes a reinforcing member that connects the upper frame member 901 and the vertical frame member 1151 and extends obliquely with respect to both members. Reference numeral 1162 denotes a reinforcing member that connects the upper frame member 911 and the vertical frame member 1161 and extends obliquely with respect to both members. Reference numeral 1154 denotes a reinforcing member that connects the upper frame member 901 and the vertical frame member 1153 and extends obliquely with respect to both members. Reference numeral 1164 denotes a reinforcing member that connects the upper frame member 911 and the vertical frame member 1163 and extends obliquely with respect to both members.

Reference numeral 1156 denotes a reinforcing member that connects the upper frame member 902 and the vertical frame member 1155 and extends obliquely with respect to both members. Note that a reinforcing member 1166 is also arranged on the left side of the vehicle so as to be symmetric with the reinforcing member 1156, and the reinforcing member 1166 is a reinforcing member that connects the upper frame member 912 and the vertical frame member 1165 and extends obliquely with respect to both members.

A battery (not illustrated) can be housed in a central space of the internal structure 90. More specifically, the battery (not illustrated) is housed in an internal space defined by the upper frame members 902 and 912, the lower frame members 951 and 961, the cylindrical members 1002 and 1003, the cylindrical members 1021 and 1022, and the vertical frame members 1153, 1163, 1155, and 1165. The battery can be placed or lowered from above the vehicle through an opening defined by the upper frame members 902 and 912 and the cylindrical members 1002 and 1003. Accordingly, the battery can be loaded and unloaded without lifting up the vehicle 10.

In addition, by providing the L-shaped cylindrical members 1021 and 1022 on the side of the battery (not illustrated), the vehicle body rigidity can be secured, and the battery can be protected from the impact of a side collision.

When the vehicle 10 is viewed from the front, the internal structure 90 has a trapezoidal shape with a narrow lower portion and a wide upper portion. As a result, the load of the cargo placed on the cargo bed at the vehicle rear can be efficiently supported, and internal components such as a battery can be arranged on the lower frame members 951 and 961 having high strength. Therefore, it is possible to protect the battery in the case where the vehicle 10 goes over an obstacle etc. or the vehicle is bumped up on a rough road.

### Fourth Embodiment

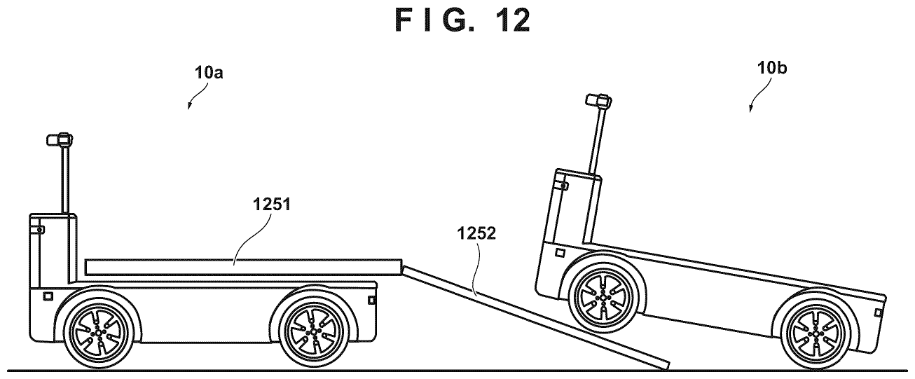

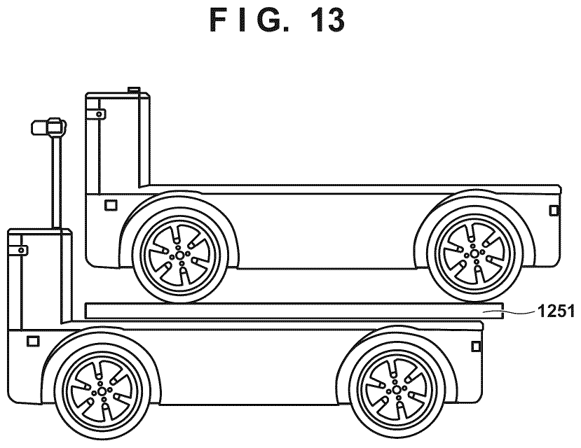

Furthermore, an example of superimposition of vehicles according to an embodiment will be described with reference to FIGS. 12 and 13. FIG. 12 is an explanatory diagram before superimposition of vehicles according to the embodiment. FIG. 13 is an explanatory diagram after superimposition of vehicles according to the embodiment.

As illustrated in FIG. 12, a rack 1251 is placed on a cargo bed of a vehicle 10a, and a ladder rail 1252 is connected to the rack 1251. In this state, a vehicle 10b rides on the ladder rail 1252 and moves forward, and after the superimposition, the ladder rail 1252 is removed. As a result, a superimposed state is obtained as illustrated in FIG. 13. Further, the vehicle 10b may be fixed to the rack 1251 after the superimposition.

In this manner, a rack on which another vehicle of the same model can be loaded and fixed is used on the cargo bed of the vehicle. As a result, since two vehicles can be arranged with respect to the footprint of one vehicle, the storage cost and the transportation cost can be reduced. In addition, in a case where a certain vehicle cannot travel due to a failure, a power failure, or the like, another vehicle can provide assistance. Therefore, it is possible to efficiently operate at low cost while not operating as a work vehicle (during non-operation).

### SUMMARY OF EMBODIMENTS

1. The vehicle (10) according to the above embodiments is a vehicle comprising:
   a rotary reference LiDAR (104);
   a plurality of fixed LiDARs (105˜109); and
   a processing unit (102) configured to execute aiming processing of the plurality of fixed LiDARs using the reference LiDAR.

Thus, aiming of a fixed LiDAR can be easily performed. Therefore, efficient aiming can be achieved.
2. In the vehicle (10) according to the above embodiments,
   the reference LiDAR has a view angle range (301) of 360 degrees in a yaw direction;
   each of the plurality of fixed LiDARs has a predetermined view angle range (302) in the yaw direction; and
   the view angle range of the reference LiDAR and the view angle range of each fixed LiDAR at least partially overlap.

Thus, by arranging the target in an arbitrary position in the overlapping range and acquiring data, it is possible to aim the fixed LiDAR using the data of the reference LiDAR.
3. The vehicle (10) according to the above embodiments, further comprising a stand (110) that is movable up and down, wherein
   the reference LiDAR is fixed to the stand, and
   the reference LiDAR is movable up and down in accordance with a lifting and lowering operation of the stand.

Thus, by performing the aiming processing in a state where the stand is lowered, the aiming processing can be performed at a position closer to the vehicle, and the aiming can be performed even in a narrow space.
4. In the vehicle (10) according to the above embodiments, the stand is installed at a front upper portion of the vehicle.

Thus, it is possible to prevent the vehicle itself from creating a blind spot when detecting the reference LiDAR.
5. In the vehicle (10) according to the above embodiments, the processing unit executes aiming processing of the plurality of fixed LiDARs in a state where the reference LiDAR is lowered.

Thus, by performing the aiming processing in a state where the reference LiDAR is lowered, the aiming processing can be performed at a position closer to the vehicle, and the aiming can be performed even in a narrow space.
6. In the vehicle (10) according to the above embodiments, a position (L2) of an overlapping region (803) between the view angle range (801) of the reference LiDAR and the view angle range (802) of each fixed LiDAR in a state where the reference LiDAR is lowered is closer to the reference LiDAR than a position (L1) of an overlapping region (703) between the view angle range (701) of the reference LiDAR and the view angle range (702) of each fixed LiDAR in a state where the reference LiDAR is lifted.

Thus, in a state where the reference LiDAR is lowered, the aiming processing can be performed at a position closer to the vehicle, and the aiming can be performed even in a narrow space.
7. In the vehicle (10) according to the above embodiments, the plurality of fixed LiDARs include:
   a front LiDAR (105) arranged at a front of the vehicle and having a predetermined view angle range around the front,
   a front right LiDAR (106) arranged on a front right side of the vehicle and having a predetermined view angle range around a front right direction,
   a front left LiDAR (107) arranged on a front left side of the vehicle and having a predetermined view angle range around a front left direction,
   a rear right LiDAR (108) arranged on a rear right side of the vehicle and having a predetermined view angle range around a rear right direction, and
   a rear left LiDAR (109) arranged on a rear left side of the vehicle and having a predetermined view angle range around a rear left direction.

Thus, it is possible to secure sufficient detection accuracy for performing automated driving of the vehicle by autonomous control.
8. In the vehicle (10) according to the above embodiments, the reference LiDAR is detachable from the vehicle.

Thus, the reference LiDAR can be removed at the time of work by the vehicle, and the reference LiDAR can be attached at the time of aiming of the fixed LiDAR. By using a reference LiDAR that is generally expensive and less likely to satisfy durability requirements for adjustment of other fixed LiDARs and removing the reference LiDAR during actual operation of the vehicle, it is possible to use one reference LiDAR for aiming of fixed LiDARs of a plurality of vehicles.

According to the present invention, efficient aiming can be achieved.

### Other Embodiments

In addition, a program for implementing one or more functions that have been described in each of the embodiments is supplied to a system or a device through a network or a storage medium, and one or more processors on a computer of the system or the device are capable of reading and executing the program. The present invention can also be implemented in such an aspect.

The invention is not limited to the foregoing embodiments, and various variations/changes are possible within the spirit of the invention.

What is claimed is:

1. A vehicle comprising:
a rotary reference LiDAR;
a plurality of fixed LiDARs; and
a processing unit configured to execute aiming processing of the plurality of fixed LiDARs using the reference LiDAR.

2. The vehicle according to claim 1, wherein:
the reference LiDAR has a view angle range of 360 degrees in a yaw direction;
each of the plurality of fixed LiDARs has a predetermined view angle range in the yaw direction; and
the view angle range of the reference LiDAR and the view angle range of each fixed LiDAR at least partially overlap.

3. The vehicle according to claim 2 further comprising a stand that is movable up and down, wherein
the reference LiDAR is fixed to the stand, and
the reference LiDAR is movable up and down in accordance with a lifting and lowering operation of the stand.

4. The vehicle according to claim 3, wherein the stand is installed at a front upper portion of the vehicle.

5. The vehicle according to claim 3, wherein the processing unit executes aiming processing of the plurality of fixed LiDARs in a state where the reference LiDAR is lowered.

6. The vehicle according to claim 3, wherein a position of an overlapping region between the view angle range of the reference LiDAR and the view angle range of each fixed LiDAR in a state where the reference LiDAR is lowered is closer to the reference LiDAR than a position of an overlapping region between the view angle range of the reference LiDAR and the view angle range of each fixed LiDAR in a state where the reference LiDAR is lifted.

7. The vehicle according to claim 1, wherein
the plurality of fixed LiDARs include:
a front LiDAR arranged at a front of the vehicle and having a predetermined view angle range around the front,
a front right LiDAR arranged on a front right side of the vehicle and having a predetermined view angle range around a front right direction,
a front left LiDAR arranged on a front left side of the vehicle and having a predetermined view angle range around a front left direction,
a rear right LiDAR arranged on a rear right side of the vehicle and having a predetermined view angle range around a rear right direction, and
a rear left LiDAR arranged on a rear left side of the vehicle and having a predetermined view angle range around a rear left direction.

8. The vehicle according to claim 1, wherein the reference LiDAR is detachable from the vehicle.
